(19) United States
(12) Patent Application Publication
(10) Pub. No.: US 2012/0176074 A1
(43) Pub. Date: Jul. 12, 2012

(54) SYSTEM FOR DECOUPLING A ROTOR FROM A STATOR OF A PERMANENT MAGNET MOTOR AND FLYWHEEL STORAGE SYSTEM USING THE SAME

(76) Inventors: Maxime R. DUBOIS, Quebec (CA); Michael DESJARDINS, Quebec (CA); Louis TREMBLAY, Quebec (CA)

(21) Appl. No.: 13/313,932

(22) Filed: Dec. 7, 2011

Related U.S. Application Data
(63) Continuation-in-part of application No. PCT/CA2010/000920, filed on Jun. 15, 2010.
Application No. PCT/CA2010/000920 is a continuation-in-part of application No. PCT/CA2010/000922, filed on Jun. 15, 2010.
(60) Provisional application No. 61/187,174, filed on Jun. 15, 2009.
(60) Provisional application No. 61/233,664, filed on Aug. 13, 2009.
(60) Provisional application No. 61/187,170, filed on Jun. 15, 2009.
(60) Provisional application No. 61/187,174, filed on Jun. 15, 2009.
(60) Provisional application No. 61/187,176, filed on Jun. 15, 2009.
(60) Provisional application No. 61/233,664, filed on Aug. 13, 2009.

(51) Int. Cl. H02P 23/00

(52) U.S. Cl. 318/540

(57) ABSTRACT

A system for decoupling a rotor from a stator of a permanent magnet motor and a flywheel storage system using the same are provided. The flywheel storage system uses the permanent magnet motor as a magnetic active coupler to minimize magnetic losses in flywheel energy storage system during the motor-generator electric power transfer for enabling a magnetic field weakening method and a way of cancelling the losses during a conservative mode where the stator is totally decoupled from the rotor. Also, the present invention enables the optimal sizing of a permanent motor-generator to be able to supply a constant power over a large range of rotating speeds.

### CROSS REFERENCE TO RELATED APPLICATIONS

This application claims priority of U.S. Patent Application having Ser. No. 61/187,174 which was filed on Jun. 15, 2009 and entitled “SYSTEM FOR DECOUPLING A ROTOR FROM A STATOR OF A PERMANENT MAGNET MOTOR AND A FLYWHEEL STORAGE SYSTEM USING THE SAME”, the specification of which is hereby incorporated by reference.

This application also claims priority of U.S. Patent Application having Ser. No. 61/233,664 which was filed on Aug. 13, 2009 and entitled “ENERGY STORAGE SYSTEM AND METHOD”, the specification of which is hereby incorporated by reference.

The present application also relates to PCT Application entitled “ENERGY STORAGE SYSTEM AND METHOD” filed on Jun. 15, 2010 by the same Applicant, the specification of which is incorporated herein by reference.

### FIELD OF THE INVENTION

The invention relates to high energy flywheel storage systems using permanent magnet motor for long term energy storage. More particularly, the invention relates to a system for decoupling a rotor from a stator of a permanent magnet motor and to a flywheel storage system using the permanent magnet motor as a coupler to supply constant power on a large speed range of flywheel operation and to allow a conservative energy mode wherein the magnetic interaction between the stator and the rotor is minimized, thereby reducing the losses of the system when no power is stored or taken from the flywheel energy storage system.

### BACKGROUND OF THE INVENTION

Flywheel energy storage systems are reliable and may be maintained at a low cost, which is of great advantage. They are generally known to supply high power during a short period of time, but are also known to be not well suited for supplying high power over a long period of time, as it will become apparent below.

In the art, a flywheel energy storage system is typically composed of five principal modules which are a containment vessel, a motor-generator, a set of bearings, a rotating shaft and a rotating disc.

The containment vessel is used to protect users from breakage of the rotating disc that may be subject to be expelled from the rotating shaft on which it is mounted. The containment vessel is also used to minimize the air friction on the rotating disc in using a vacuum pump to extract most of the air inside the containment vessel.

The motor-generator enables the electro-mechanical conversion from electric energy to kinetic energy and vice versa.

The bearings are used to conveniently support the rotating shaft and the rotating disc.

The rotating disc, also called a wheel, is used to store kinetic energy (E) therein according to the weight (M) of the disc, the square of the radius (R) of the disc and the square of the rotating speed (ω) of the disc.

In a typical flywheel energy storage system, there are four types of losses: aerodynamics, electrics, magnetics and by friction. The latest are caused by the friction between two pieces, such as between mechanical bearings. They are proportional to the rotating disc weight and to the square of the rotating speed.

The magnetic losses are produced by the variation of the magnetic induction in ferromagnetic material and they are proportional to the square of the rotating speed of the disc. They can be found in the motor-generator or in the magnetic bearings. The electric losses or copper losses are found in the copper coil of the motor-generator or in the magnetic bearings. Finally, aerodynamic losses are essentially the losses due to the friction of the rotating parts of the flywheel with the air in the containment vessel.

Minimizing those losses is not easy to achieve because they are all interrelated. For instance, the reduction of friction losses can be achieved with magnetic bearings instead of mechanical bearings, but that particular embodiment will increase the magnetic and electric losses of the whole system. That embodiment will also increase the cost of the energy storage system but is nevertheless generally preferred in the art to accomplish viable long term energy storage.

Permanent magnet motor-generators are known for their high power density, their reliability and their controllability. They are however also known for their iron losses at no load and their short range of speed at a constant power, two major drawbacks for the flywheel energy storage systems of the art. The short range of speed at a constant power of permanent magnet motor-generators is addressed in the art in different ways.

Typically, a permanent magnet motor-generator can store or retrieve a constant power over a particular speed called base speed. Below the base speed, the motor-generator power decreases linearly with the rotating speed until it reaches zero. Base speed is a particular speed where the voltage created by the variation of the magnetic induction produced by the rotation of the magnet on the rotor in the stator coil is equal to the nominal voltage of the stator. This voltage is called back-electromagnetic-force or back-emf. To overcome that limit, various methods have been proposed in the art.

In a first method, field weakening of the permanent magnet of the rotor is achieved by supplying high current from the inverter that supplies the motor-generator. This particular method requires the oversizing of the supplying inverter and increases the losses of the inverter and of the motor-generator.

In a second method, the voltage supplied to the motor-generator is increased with a boost converter, thereby allowing to overcome the base speed of the motor-generator. This second method however requires that the electric components of the inverter as well as the motor-generator insulation be adapted to support higher voltage rate.

It would therefore be desirable to provide a system and a method for use with flywheel energy storage systems that will reduce at least one of the above mentioned drawbacks.

### BRIEF SUMMARY

Accordingly, the invention provides a system for decoupling a rotor from a stator of a permanent magnet motor comprising a displacement mechanism operatively connected to a selected one of the stator and the rotor for displacing the selected one of the stator and the rotor between a first position wherein the stator extends around the rotor and a second position wherein the stator extends away from the rotor and is decoupled from the rotor. The system for decoupling a rotor from a stator of a permanent magnet motor comprises actuating means operatively coupled to the displacement mechanism for actuating the displacement mechanism and a control unit for controlling the actuating means. The relative displacement of the stator away from the rotor enables a rotational speed of the permanent magnet motor greater than a base speed thereof.

The system for decoupling a rotor from a stator of a permanent magnet motor enables to increase the range of speed of the motor that admits constant power, which is of great advantage.

The system for decoupling a rotor from a stator of a permanent magnet motor enables to totally decouple the rotor from the stator of the motor to cancel the magnetic losses during a conservative mode, which is of great advantage.

In one embodiment, the permanent magnet motor comprises a permanent magnet motor-generator.

In one embodiment, the displacement mechanism is connected to the stator for displacing the stator.

In another embodiment, the displacement mechanism is connected to the rotor for displacing the rotor.

In another embodiment, the displacement mechanism enables a continuous motion of the selected one of the stator and the rotor between the first position and the second position.

In a further embodiment, the stator and the rotor have no magnetic interaction when extending in the second position, to thereby reduce magnetic losses in the permanent magnet motor.

In one embodiment, the actuating means is selected from a group consisting of a servomotor, a pneumatic actuator and a hydraulic actuator.

In one embodiment, the control unit comprises a servomotor controller.

In yet a further embodiment, the system further comprises a speed sensor for sensing the rotational speed of the permanent magnet motor.

In one embodiment, the control unit controls the relative displacement of the stator away from the rotor according to the sensed rotational speed of the permanent magnet motor.

In still a further embodiment, the system further comprises a position sensor for sensing a relative position of the stator with respect to the rotor.

In one embodiment, the displacement mechanism is connected to the stator for displacing the stator, the displacement mechanism comprising a casing connected to the stator, the casing comprising a first threaded hole and a second threaded hole longitudinally extending therethrough, the displacement mechanism further comprising a first lead screw and a second lead screw adapted for extending in a corresponding one of the first and second holes, the actuating means comprising a first and a second servomotor, each being operatively connected to a respective one of the first and second lead screws for moving the casing therealong, thereby moving the stator between the first position and the second position.

In a further embodiment, the permanent magnet motor is adapted to supply a constant power over a given large rotational speed range adapted to an operating rotational speed range of a flywheel operatively connected to the permanent magnet motor.

In one embodiment, the given large rotational speed range is comprised between 2600 rpm and 8000 rpm.

According to another aspect, there is also disclosed a method for decoupling a rotor from a stator of a permanent magnet motor comprising sensing a rotational speed of the permanent magnet motor; and displacing a selected one of the stator and the rotor between a first position wherein the stator extends around the rotor and a second position wherein the stator extends away from the rotor and is decoupled from the rotor according to the sensed rotational speed; wherein a relative displacement of the stator away from the rotor enables a rotational speed of the permanent magnet motor greater than a base speed thereof.

In one embodiment, the displacing is performed in a continuous manner.

According to another aspect, there is also disclosed a flywheel energy storage system comprising a permanent magnet motor-generator having a stator and a rotor, and a rotating disc operatively connectable to the rotor. The flywheel energy storage system comprises a system for decoupling a rotor from a stator of a permanent magnet motor as previously defined, the system being operatively connected to the permanent magnet motor-generator for enabling a decoupling of the stator of the permanent magnet motor-generator from the rotor thereof.

In one embodiment, the flywheel energy storage system further comprises a vacuum containment vessel enclosing the flywheel energy storage system.

In one embodiment, the flywheel energy storage system further comprises a coupling element, a magnetic coupling element for a non-limitative example, for operatively connecting the rotating disc to the rotor.

In one embodiment, the rotor extends around the stator and the rotating disc extends around the rotor, the system further comprising a coupling element for operatively coupling the rotor and the rotating disc together.

In a further embodiment, the coupling element comprises a plurality of magnets mounted on an inner surface of the rotating disc.

In another embodiment, the flywheel energy storage system further comprises a rotating shaft operatively connected to the rotor and the rotating disc.

In one embodiment, the rotating shaft is fixedly mounted with the rotor.

In one embodiment, the rotating disc is mounted to the rotating shaft via a first coupling and a second coupling.

In another embodiment, the rotating disc is mounted on a disc shaft operatively coupled to the rotating shaft via a coupling mechanism.

In a further embodiment, the coupling mechanism comprises a magnetic clutch.

In one embodiment, the flywheel energy storage system further comprises an additional displacement mechanism for displacing a selected one of the rotating shaft and the disc shaft away from the remaining one of the rotating shaft and the disc shaft to prevent interaction therebetween.

In one embodiment, the flywheel energy storage system is adapted for operatively coupling the rotating shaft to at least one additional rotating disc.

The flywheel energy storage system may provide high efficiency energy storage, particularly for long term energy storage applications, which is of great advantage.

The energy storage system may be useful in charging infrastructure for full electric vehicles or plug-in hybrid electric vehicles at a constant rate, to support the electric grid for load leveling, peak shaving, voltage and frequency regulation, renewable energy integration and for other applications where constant or variable power is necessary, which is of great advantage.

### BRIEF DESCRIPTION OF THE DRAWINGS

In order that the invention may be readily understood, embodiments of the invention are illustrated by way of example in the accompanying drawings.

FIG. 1 is a schematics of a system for decoupling a rotor from a stator of a permanent magnet motor according to one embodiment, the system being mounted with a flywheel energy storage system, the stator and the rotor being coupled together.

FIG. 2 is a cross sectional view of an embodiment of a system for decoupling a rotor from a stator of a permanent magnet motor, the system being mounted with a flywheel energy storage system, the stator and the rotor being coupled together.

FIG. 3 is a cross sectional view of the system shown in FIG. 2, the stator and the rotor being half coupled together.

FIG. 4 is a cross sectional view of the system shown in FIG. 2, the stator and the rotor being decoupled from each other.

FIG. 5 is a cross sectional view of another embodiment of a flywheel energy storage system using a system for decoupling a rotor from a stator of a permanent magnet motor, the rotating disc being magnetically coupled to the permanent magnet motor.

FIG. 6 is a cross sectional view of the flywheel energy storage system shown in FIG. 5, the rotating disc being decoupled from the permanent magnet motor.

FIG. 7 is a cross sectional view of another embodiment of a flywheel energy storage system using a system for decoupling a rotor from a stator of a permanent magnet motor, the system being adapted to be coupled to a plurality of rotating discs through a magnetic clutch.

FIG. 8A shows a graphic illustrating the relationship between power, torque and speed of a permanent magnet motor of a flywheel energy storage system using a system for decoupling a rotor from a stator.

FIG. 8B is a graph illustrating the relationship between the voltage and the speed of a permanent magnet motor for different values of the magnetic flux.

FIG. 9A to 9C show different relative positions of the stator and the rotor of a permanent magnet motor.

FIG. 10A to 10C show different magnetic flux patterns in the rotor for the respective positions shown in FIG. 9A to 9C.

FIG. 11 is a flow chart of an embodiment of a method for decoupling a rotor from a stator of a permanent magnet motor.

Further details of the invention and its advantages will be apparent from the detailed description included below.

### DETAILED DESCRIPTION

In the following description of the embodiments, references to the accompanying drawings are by way of illustration of examples by which the invention may be practiced. It will be understood that other embodiments may be made without departing from the scope of the invention disclosed.

As known to the skilled addressee, the range of rotational speed in which a permanent magnet motor is able to provide a constant power is very limited, which is a great drawback for various given applications.

As it will become apparent upon reading of the present description, the system for decoupling a rotor from a stator of a permanent magnet motor, hereinafter also referred to as the decoupling system or the magnetic active coupler, enables the increasing of the range of speed on which constant power may be provided, which is of great advantage.

The system also enables a conservative mode where the stator is totally decoupled from the rotor, which is of great advantage since it enables reducing the magnetic losses of the motor, as it will become apparent below.

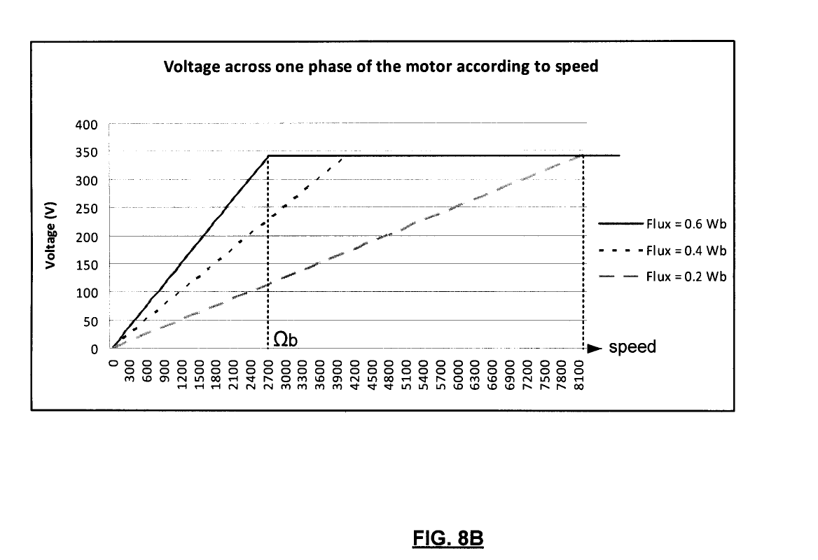

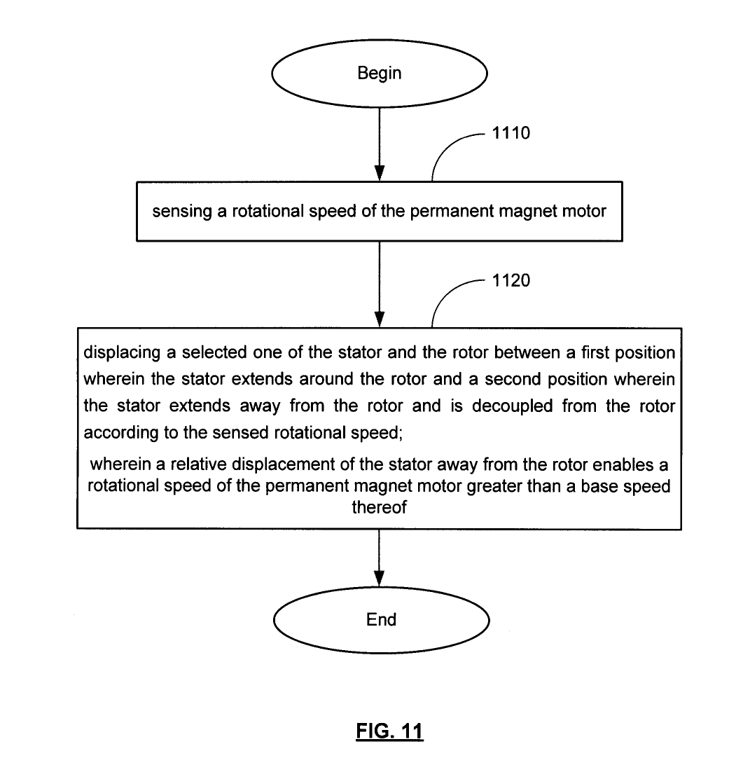

FIG. 9A to 9C illustrates the general principles of the system for decoupling a rotor 23 from a stator 24 of a permanent magnet motor according to the invention. As illustrated, the displacement of the stator 24, which comprises laminations 1 and coils 2 assemblies in the illustrated case, from the magnet 3 of the rotor 23 creates various magnetic flux patterns in the coils 2 of the stator, as illustrated in FIG. 10A to 10C. The skilled addressee will appreciate that although sinusoidal magnetic flux patterns are shown, various other patterns may be used.

FIG. 9A shows the normal mode of operation of a permanent magnet motor. In this normal mode of operation, the rotor 23 and the stator 24 of the permanent magnet motor are totally coupled together. The available output power is proportional to the speed of rotation of the motor between 0 rpm and the base speed. In other words, and as it will be more clearly understood upon reading of the present description, in the case the permanent magnet motor is a permanent magnet motor-generator, the power that the motor-generator may absorb to rotate the disc of a flywheel coupled thereto or the power that the motor-generator may supply from the inertia of the disc varies linearly. In this range, the motor-generator is able to provide a constant torque.

FIG. 9B shows the field weakening mode of operation of a permanent magnet motor-generator using a decoupling system. This mode of operation is comprised between the base speed and a maximal flywheel speed defined by the maximal yield strength, also called yield stress or elastic constrain, of the material of the rotating disc operatively connected to the motor. For a flywheel allowing a suitable high rotational speed, this maximal flywheel speed may be above the maximal speed allowed by the same motor-generator not equipped with a decoupling system, which is of great advantage.

In this particular mode, as the speed increases, a control unit (not shown), comprising for example a servomotor controller, will command an actuating means (not shown) to gradually decouple the stator from the rotor, according to the actual speed of the rotating disc (not shown). In one embodiment, the actuating means may be selected from a group consisting of a servomotor, a pneumatic actuator and an hydraulic actuator. In a further embodiment, a plurality of actuators or cylinders may be used. The skilled addressee will appreciate that various other actuating means as well as various other control units may be considered.

The skilled addressee will also appreciate that the relative displacement of the rotor with respect to the stator may be implemented such that the displacement may be a continuous motion. Alternatively, the motion may be implemented using incremental discrete displacements.

In one embodiment, the actual speed may be measured with an optical sensor but the skilled addressee will appreciate that various other arrangements may be alternatively considered.

Moreover, in a further embodiment, a position sensor for sensing a relative position of the stator with respect to the rotor may be used. In still a further embodiment, a feedback loop may be implemented for a given application.

FIG. 9C shows the conservative mode of operation of a permanent magnet motor-generator using a decoupling system. This conservative mode occurs when no power is needed from the rotating disc and when no power is available from the power supply upwards the stator. In others words, in this mode, there is no power exchange between the rotor and the stator. In this mode, the servomotor controller totally decouples the stator from the rotor, as will be detailed hereinafter.

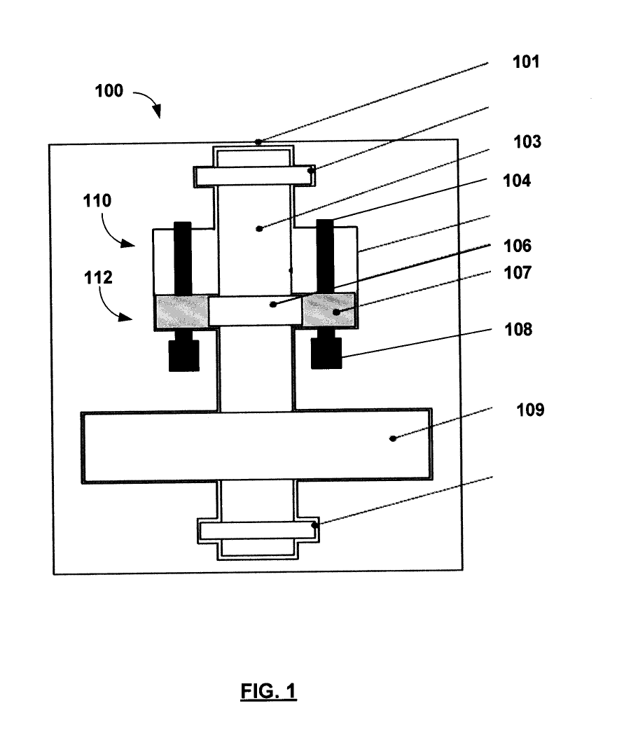

FIG. 1 shows a flywheel energy storage system 100 using a system 110 for decoupling a rotor 106 from a stator 107 of a permanent magnet motor 112. The system 110 for decoupling a rotor 106 from a stator 107 of a permanent magnet motor 112 comprises a displacement mechanism 104 operatively connected to a selected one of the stator 107 and the rotor 106, the stator 107 in the illustrated case, for displacing the selected one of the stator 107 and the rotor 106 between a first position wherein the stator 107 extends around the rotor 106 and a second position wherein the stator 107 extends away from the rotor 106 and is decoupled from the rotor 106.

The system 110 for decoupling a rotor 106 from a stator 107 of a permanent magnet motor 112 also comprises actuating means 108 operatively coupled to the displacement mechanism 104 for actuating the displacement mechanism 104.

The system 110 for decoupling a rotor 106 from a stator 107 of a permanent magnet motor 112 also comprises a control unit (not shown) for controlling the actuating means 108.

As illustrated and as further detailed thereinafter, in one embodiment, the flywheel energy storage system 100 comprises a shaft 103 operatively coupled to the system 110 for driving a rotating disc 109. In the illustrated embodiment, the flywheel energy storage system 100 is mounted inside a containment vessel 101.

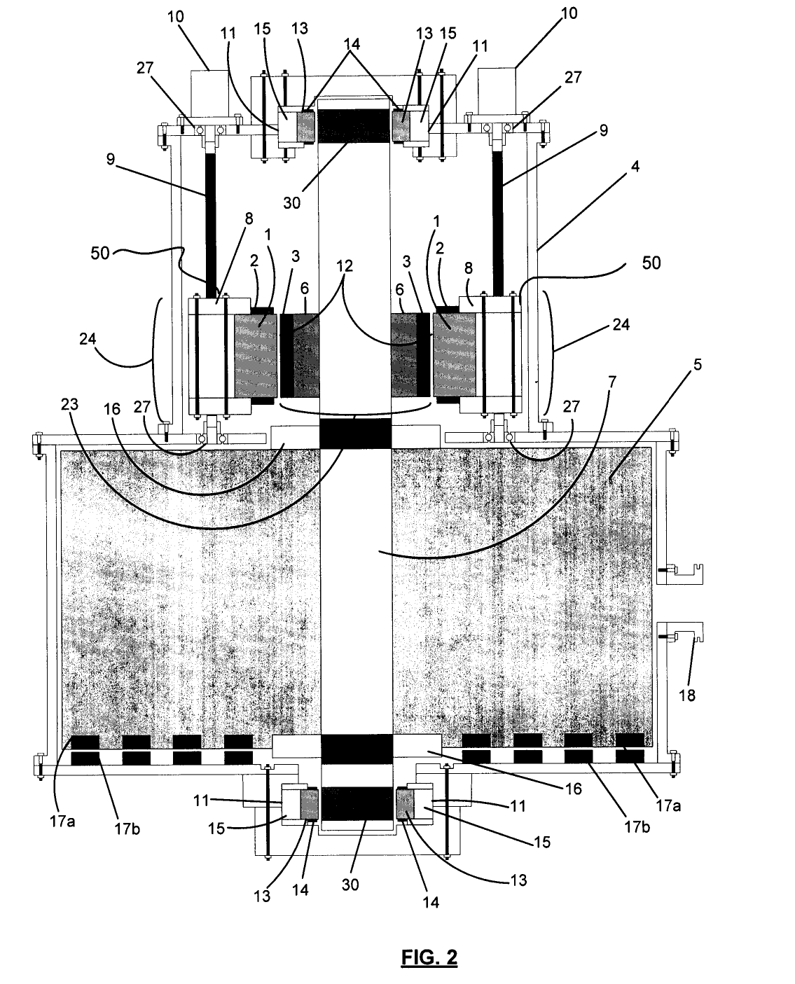

FIGS. 2 to 4 show an embodiment of a system for decoupling a rotor 23 from a stator 24 of a permanent magnet motor, the system being mounted with a flywheel energy storage system. In this embodiment, the flywheel energy storage system uses the permanent magnet motor as a magnetic active coupler for the rotating disc.

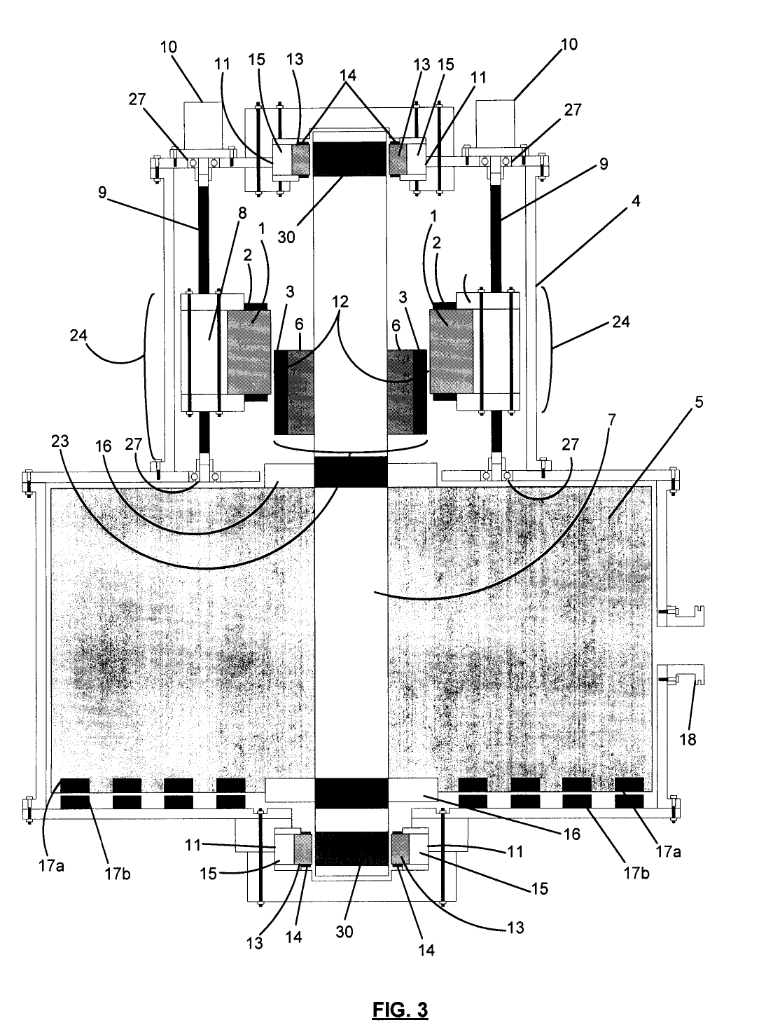

FIG. 2 shows the system for decoupling a rotor 23 from a stator 24 of a permanent magnet motor in the first position wherein the stator 24 extends around the rotor 23 and is coupled thereto. FIG. 4 shows the system for decoupling a rotor from a stator of a permanent magnet motor in the second position wherein the stator 24 extends away from the rotor 23 and is decoupled from the rotor 23. In other words, in this position, there is no magnetic interaction between the rotor 23 and the stator 24. FIG. 3 shows the system in an intermediate position wherein the stator 24 is partially decoupled from the rotor 23. This intermediate position enables the field weakening mode of operation described above with reference to FIG. 9B.

Still referring to FIGS. 2 to 4, an embodiment of a flywheel storage system using the system for decoupling a rotor from a stator of a permanent magnet motor described above will be described.

The motor, also called a motor-generator, is used as a magnetic active coupler and is designed to minimize the range of speed in the normal mode of operation and to maximize the range of speed that admits constant power, as it will become apparent below.

As illustrated in FIG. 2 and in one embodiment, the flywheel storage system comprises a flywheel rotating disc 5 and a containment vessel 4 enclosing the rotating disc 5 and the motor-generator provided with the rotor 23 and the stator 24. As previously mentioned, the motor-generator illustrated in FIG. 2 is in the normal position, also called first position, where the rotor 23 is aligned with the stator 24 for enabling a maximum magnetic coupling.

In one embodiment, the rotor 23 is made of an iron element 6 and rotates at the same speed than the electric frequency. Magnets 3 are attached, with glue for example, on the iron element 6 of the rotor 23 and the rotor 23 is fixedly mounted to the rotating shaft 7. Glue may be used for mounting the rotor 23 and the rotating shaft 7 together, although other arrangements may be considered.

In the illustrated embodiment, the rotor 23 is maintained as it rotates in the stator 24 and the stator 24 is displaceable for enabling the field weakening operation mode and the conservative operation mode.

The stator 24, which comprises laminations 1 and coils 2 in the illustrated case, is supported by an aluminum casing 8 to avoid magnetic interaction between the stator 24 and the casing 8 but any other suitable material preventing magnetic interaction may be used.

In the illustrated embodiment, the aluminum casing 8 supporting the stator 24 has a first and a second threaded hole 50 adapted for receiving a first and a second screw 9 respectively. The first and second screws 9, which may be lead screws in one embodiment, are driven by a first servomotor and a second servomotor 10 controlled by a servomotor controller (not shown) for precise displacement of the stator 24 according to the suitable speed that the system requires.

In one embodiment, the servomotors 10 are mounted externally to the containment vessel 4 to minimize air leaks from the wires. In this case, a seal (not shown) is mounted between the containment vessel 4 and the servomotors 10.

In one embodiment, the rotation of the lead screws 9 driven by the servomotors 10 is assured by mechanical bearings 27 but the skilled addressee will appreciate that other types of bearings may be used, such as, for a non-limitative example, magnetic bearings. In the normal position of the stator 24, as shown in FIG. 2, the lead screws 9 maintained the stator 24 in a way that the air gap 12 between the stator 24 and the rotor 23 is constant.

In the illustrated embodiment, the rotor 23 of the motor-generator and the rotating disc 5 are coupled together and to a rotating shaft 7. They are axially maintained by an upper and a lower magnetic bearing 11 to minimize the friction losses that may be caused by mechanical bearings. In one embodiment, the magnetic bearings 11 contained laminations 13 and coils 14 which are supported by an aluminum casing 15 to avoid magnetic interaction with the casing but any other suitable material preventing magnetic interaction may be used. In one embodiment, the rotating part 30 of the magnetic bearings 11 is made of ferromagnetic material to minimize the magnetic losses in the magnetic bearings 11.

In one embodiment, the rotating disc 5 is maintained on the rotating shaft 7 by two couplings 16. Moreover, the rotating disc 5 lies on a set of opposite magnets 17a, 17b. In this way, the rotating disc 5 levitates above the set of bearings 17b and the friction losses are minimized, which is of great advantage. As known to the skilled addressee, modifications to the number of magnets 17a, 17b as well as to their positioning may be envisaged for a particular application. In one embodiment, the upper magnets 17a proximate the rotating disc 5 are embedded in the rotating disc 5 while the lower magnets 17b are mounted on the containment vessel 4.

The skilled addressee will nevertheless appreciate that various other arrangements may be envisaged without departing from the scope of the disclosure, as it will become apparent below. For a non-limitative example, it may be considered to use magnets mounted under the rotor and/or magnetic coils mounted to the containment vessel.

The skilled addressee will appreciate that the rotating disc 5 may be made of different materials and may have different geometry without departing from the spirit and the scope of the invention described herein. For example, the rotating disc 5 may be designed as described in co-pending PCT application entitled “HIGH ENERGY DENSITY FLYWHEEL”, the specification of which is hereby incorporated by reference.

Still referring to FIG. 2, in one embodiment, the flywheel storage system comprises a vacuum pump (not shown) mounted with the containment vessel 4 to effect a vacuum inside the vessel 4 in order to minimize air friction on the rotating disc 5 of the flywheel energy storage system. In one embodiment, the containment vessel 4 comprises a plug 18 for mounting the vacuum pump thereto.

In the embodiment illustrated in FIG. 3, the stator 24 is 50% decoupled from the rotor 23. Therefore, there is less magnetic interaction between the rotor 23 and the stator 24, as previously explained. In the embodiment illustrated in FIG. 4, the stator 24 is totally decoupled from the rotor 23. Therefore, there is no magnetic interaction between the rotor 23 and the stator 24.

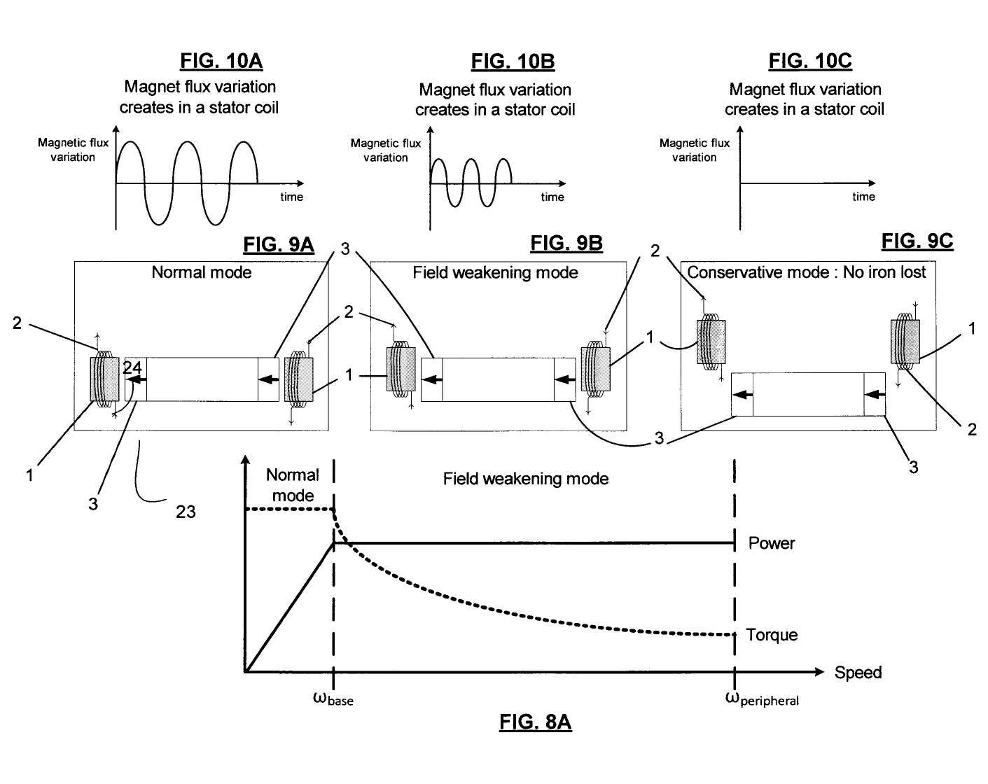

FIG. 8A is a graph illustrating the relationship between power, torque and speed of a permanent magnet motor using a decoupling system while FIG. 8B is a graph illustrating the relationship between the voltage across one of the phase of a permanent magnet motor and the speed of the permanent magnet motor for different values of the magnetic flux.

As previously mentioned and as well illustrated in FIG. 8B, a relative displacement of the stator away from the rotor enables a rotational speed of the permanent magnet motor greater than a base speed thereof.

Indeed, as known to the skilled addressee. The electromotive force seen by a coil having n turns is:

$${e}^{′} = - n \frac{d ϕ}{d t} or {e}^{′} = - \frac{d Φ}{d t}$$

Where Φ is the total magnetic flux seen by the n turns of the coil and E′ is the electromotive force seen by the coil of a phase of the permanent magnet motor.

In a permanent magnet motor having a rotor and a stator, the back-electromotive force E is:

E=pΩΦ_{V}

Where p is the number of pairs of poles for each phase of the motor, Φ_{V} is the magnetic flux at no load for each phase and Ω is the rotational speed of the rotor of the motor.

As it can be seen, the back-electromotive force E increases with an increase of the rotational speed of the motor until E reaches the supply voltage of the motor. In order to prevent saturation of the supply voltage source supplying the motor-generator, one may reduce the magnetic flux Φ_{V} seen by the coils.

FIG. 8B shows the relationship between the voltage and the speed of a permanent magnet motor for a nominal value of the magnetic flux of 0.6 Wb, as well as for reduced values of the magnetic flux, i.e. a flux of 0.4 Wb and a flux of 0.2 Wb. As it should be apparent to the skilled addressee, these reduced values of the magnetic flux have been obtained in performing a relative displacement of the rotor with respect to the stator with a decoupling system.

As shown, it may be advantageous to reduce the magnetic flux seen by the motor once the base speed Ωb (2600 rpm in the illustrated case) of the machine has been reached and until reaching the maximal allowed speed of the motor. As previously mentioned, a faster speed than the base speed of the motor may be advantageous when the system is used with an energy storage flywheel allowing a rotational speed greater than the base speed of the motor.

As known to the skilled addressee, the losses at no load in the permanent magnet machine mainly comprise magnetic losses. The magnetic losses comprise the hysteresis losses and the losses induced by eddy currents. These two types of losses are directly dependant of the magnetic induction induced in the motor.

When the stator and the rotor of the motor are decoupled from each other, there is no magnetic interaction between the rotor and the stator and the magnetic induction is then negligible or even nil. Therefore, each of the hysteresis losses and the losses induced by eddy currents are also negligible or even nil.

The skilled addressee will appreciate that the decoupling system may be of great advantage when used with a flywheel energy storage system.

Indeed, for a given motor-generator designed for a power of 200 kW at a rotational base speed of 1500 rpm, calculation have shown that the magnetic losses are approximately 553 W. In other words, in the case the motor-generator is used with a 25 kWh flywheel, the flywheel should theoretically lost about 53% of its charge after a period of 24 hours due to the magnetic losses, which is not acceptable for a long term storage application.

The skilled addressee will therefore appreciate that the decoupling system is of great advantage in the case it is used in combination with a flywheel energy storage system for long term storage applications.

Referring again to FIG. 8B, the increasing of the operating rotational speed range is shown. The skilled addressee will appreciate that constant power may be extract or stock on the whole range of speed, which is of great advantage. In the illustrated embodiment, the operating rotational speed range is comprised between 2600 rpm, i.e. the base speed, and 8000 rpm, i.e. the maximal rotational speed allowed by the motor-generator or the maximal rotational speed allowed by the mechanical characteristics of the rotating flywheel, although other arrangements may be considered. As previously mentioned, this is particularly advantageous when using a flywheel having a high rotational speed much greater than the base speed of the motor-generator.

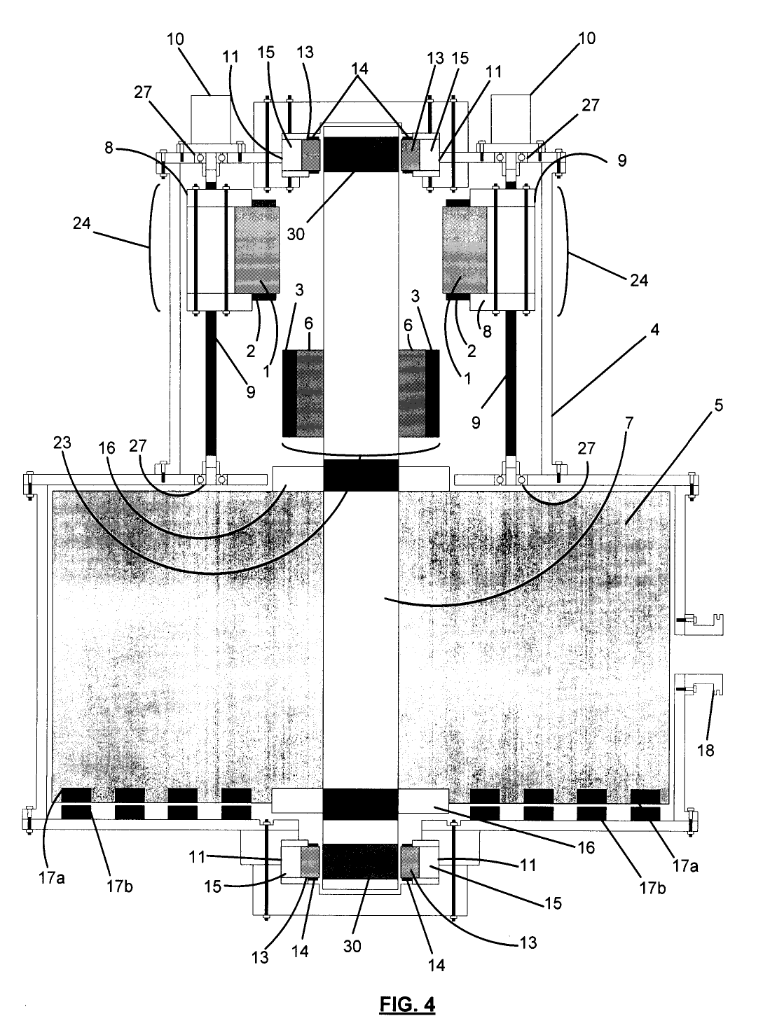

Referring now to FIGS. 5 and 6, another embodiment of a flywheel energy storage system using a permanent magnet motor-generator as a magnetic active coupler will be described. In the illustrated embodiment, the rotating disc 5 is mounted in its own hermetic containment vessel 19 (shown in FIG. 6) which is isolated from the magnetic active coupler, i.e. the permanent magnet motor-generator. A coupling mechanism such as a magnetic clutch is used to operatively couple the motor-generator to the rotating disc 5.

This embodiment provides an isolation of the rotating disc 5 from the magnetic active coupler by a non magnetic element 21 to enable minimizing the overall volume of air that should be vacuumed.

The motor-generator comprising the rotor 23 and the stator 24 is mounted in its own containment vessel 26 (shown in FIG. 6) while the rotating disc 5 is mounted in its own containment vessel 19. The containment vessel 26 of the motor-generator may not be vacuumed while the containment vessel 19 of the rotating disc 5 may be vacuumed through the vacuum plug 18.

In the illustrated embodiment, the rotor 23 of the motor-generator rotates with the rotating shaft 28 (shown in FIG. 6) while the rotating disc 5 rotates with the rotating shaft 29 (shown in FIG. 6). The rotating shaft 29 is axially maintained with two magnetic bearings 11 in order to minimize the friction losses caused by mechanical bearings. The shaft 28 of the motor-generator is linked to the shaft 29 associated to the rotating disc 5 through a magnetic clutch 20. The magnetic clutch 20 enables a torque transfer between both shafts 28, 29 without any mechanical contact. In the illustrated embodiment, the magnetic clutch 20 comprises two sets of magnets 31 lying on an iron disc 32 that assure the torque transfer.

In a further embodiment, as best shown in FIG. 6, the magnetic active coupler may be pulled apart from the isolated rotating disc 5. To this effect, the flywheel energy storage system comprises mechanical bearings 33 (shown in FIG. 6) on the shaft 28 of the motor-generator. In this way, the magnetic active coupler may be pulled apart from the rotating disc containment vessel 19 when it is in the conservative mode to thereby cancel the friction and the aerodynamic losses caused by the rotating parts on the side of the motor-generator containment vessel 26. The mechanical bearings 33 may comprise oil film bearings, but the skilled addressee will appreciate that any other types of bearings may be used.

The motor-generator containment vessel 26 may be pulled apart from the rotating disc containment vessel 19 by a suitable mechanism (not shown), which may be a mechanical mechanism, a robotic mechanism, a pneumatic mechanism or any convenient means adapted to achieve the required displacement.

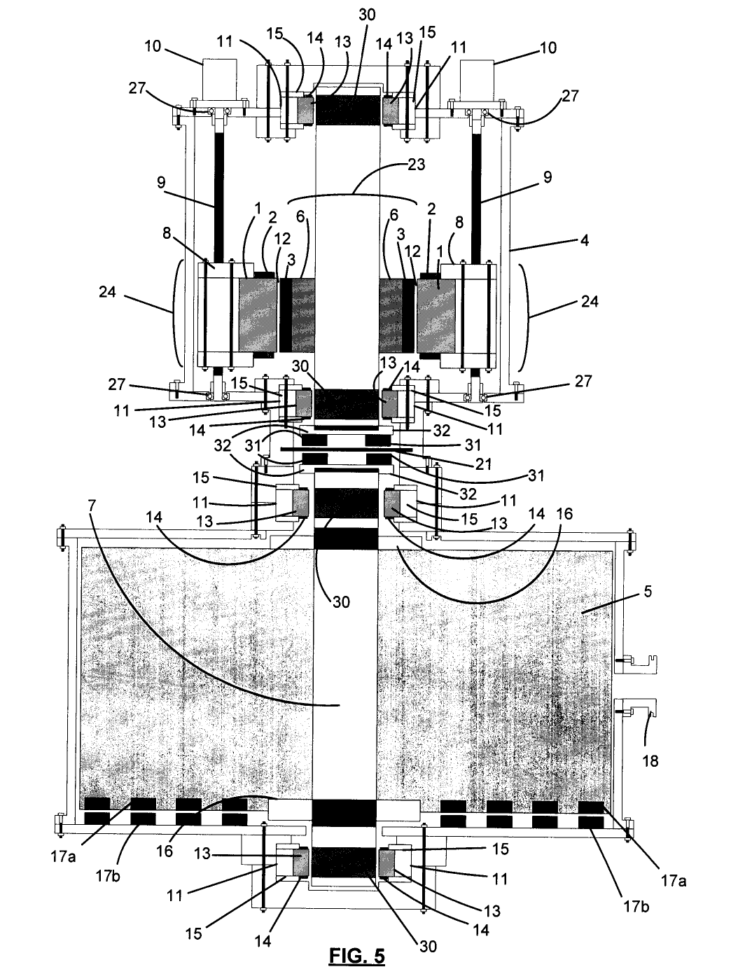

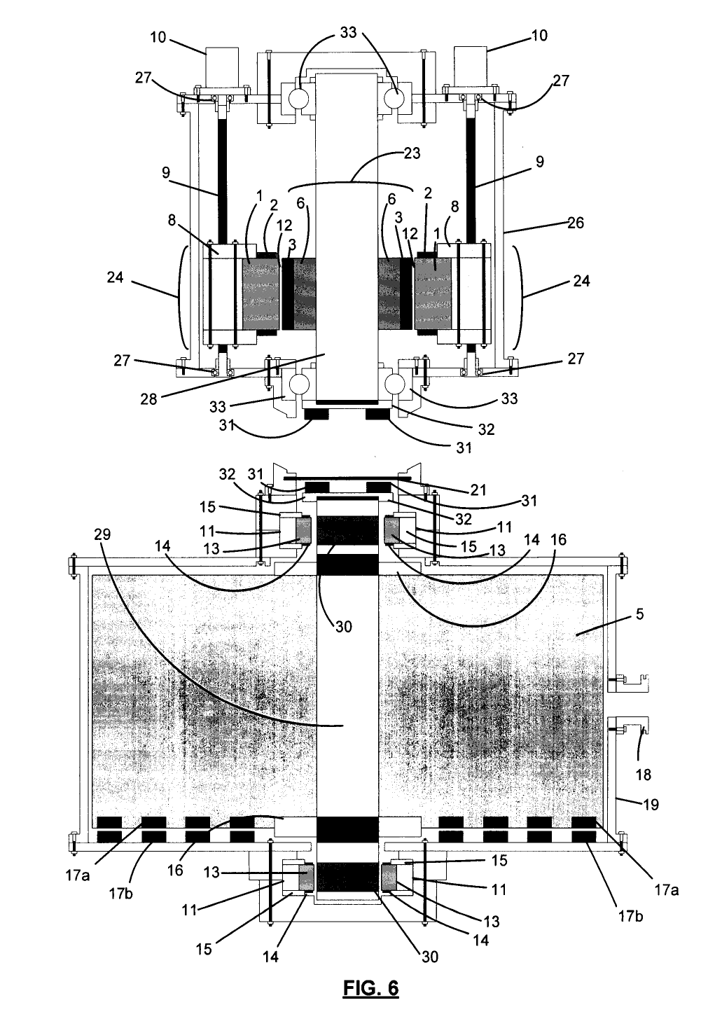

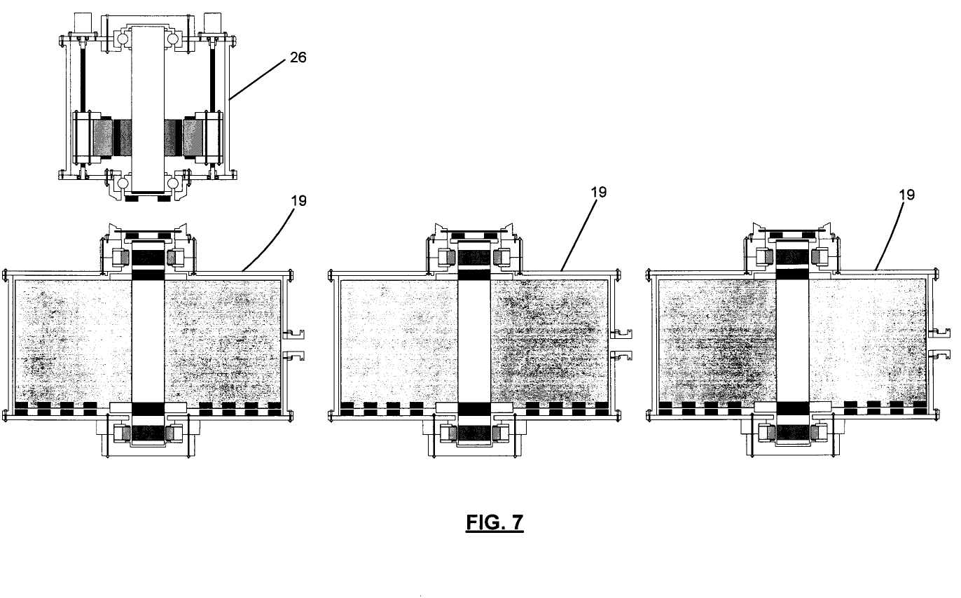

Referring now to FIG. 7, the flywheel energy storage system described above may be adapted to be coupled to a plurality of independent rotating discs 5, three in the illustrated case and as a non-limitative example. In this case, an additional displacement mechanism (not shown) is provided for displacing either the containment vessel 26 either the containment vessels 19 in a suitable manner so that kinetic energy may be stored in any of the discs 5, according to their respective actual energy density in one embodiment.

From the above description, the skilled addressee will appreciate that the system for decoupling a rotor from a stator of a permanent magnet motor may enable to provide a high efficiency and high energy density flywheel energy storage system for long term energy storage applications.

The skilled addressee will also appreciate that such a system, even if well adapted for long term storage such as for example a range of 24 hours or more, may nevertheless be particularly useful for medium term applications ranging from one hour to few hours. He will also appreciate that the system may also be suitable for short term applications.

The energy storage system may be useful in charging infrastructure for full electric vehicles or plug-in hybrid electric vehicles at a constant rate, to support the electric grid for load leveling, peak shaving, voltage and frequency regulation, renewable energy integration and for other applications where constant or variable power is necessary, which is of great advantage.

According to another aspect, referring to FIG. 11, there is disclosed a method for decoupling a rotor from a stator of a permanent magnet motor.

According to processing step 1110, a rotational speed of the permanent magnet motor is sensed.

According to processing step 1120, a selected one of the stator and the rotor is displaced between a first position wherein the stator extends around the rotor and a second position wherein the stator extends away from the rotor and is decoupled from the rotor according to the sensed rotational speed.

Throughout the present description, the system and the method for decoupling a rotor from a stator of a permanent magnet motor and the flywheel storage system using such a decoupling system have been described with a movable stator. The skilled addressee will however appreciate that other embodiments wherein the rotor is moved apart from the stator may be considered and are within the scope of the present invention.

Although the above description relates to specific preferred embodiments as presently contemplated by the inventors, it will be understood that the invention in its broad aspect includes mechanical and functional equivalents of the elements described herein. For example, while the system for decoupling a stator form a rotor of a permanent magnet motor has been described in applications using flywheel energy storage systems, the skilled addressee will nevertheless appreciate that the invention is not limited to this particular application and that various other applications may be considered (like automotive applications, in electric vehicles for example).

1-27. (canceled)

28. A system for decoupling a rotor from a stator of a permanent magnet motor comprising:
a displacement mechanism operatively connected to a selected one of the stator and the rotor for displacing the selected one of the stator and the rotor between a first position wherein the stator extends around the rotor and a second position wherein the stator extends away from the rotor and is decoupled from the rotor;
actuating means operatively coupled to the displacement mechanism for actuating said displacement mechanism; and
a control unit for controlling the actuating means;
wherein a relative displacement of the stator away from the rotor enables a rotational speed of the permanent magnet motor greater than a base speed thereof.

29. The system for decoupling a rotor from a stator of a permanent magnet motor according to claim 28, wherein the permanent magnet motor comprises a permanent magnet motor-generator.

30. The system for decoupling a rotor from a stator of a permanent magnet motor according to claim 28, wherein the displacement mechanism is connected to the stator for displacing said stator.

31. The system for decoupling a rotor from a stator of a permanent magnet motor according to claim 28, wherein the displacement mechanism is connected to the rotor for displacing said rotor.

32. The system for decoupling a rotor from a stator of a permanent magnet motor according to claim 28, wherein the displacement mechanism enables a continuous motion of the selected one of the stator and the rotor between the first position and the second position.

33. The system for decoupling a rotor from a stator of a permanent magnet motor according to claim 28, wherein the stator and the rotor have no magnetic interaction when extending in the second position, to thereby reduce magnetic losses in the permanent magnet motor.

34. The system for decoupling a rotor from a stator of a permanent magnet motor according to claim 28, wherein the actuating means is selected from a group consisting of a servomotor, a pneumatic actuator and an hydraulic actuator.

35. The system for decoupling a rotor from a stator of a permanent magnet motor according to claim 28, wherein the control unit comprises a servomotor controller.

36. The system for decoupling a rotor from a stator of a permanent magnet motor according to claim 28, further comprising a speed sensor for sensing the rotational speed of the permanent magnet motor.

37. The system for decoupling a rotor from a stator of a permanent magnet motor according to claim 36, wherein the control unit controls the relative displacement of the stator away from the rotor according to the sensed rotational speed of the permanent magnet motor.

38. The system for decoupling a rotor from a stator of a permanent magnet motor according to claim 28, further comprising a position sensor for sensing a relative position of the stator with respect to the rotor.

39. The system for decoupling a rotor from a stator of a permanent magnet motor according to claim 28, wherein the displacement mechanism is connected to the stator for displacing said stator, the displacement mechanism comprising a casing connected to the stator, said casing comprising a first threaded hole and a second threaded hole longitudinally extending therethrough, the displacement mechanism further comprising a first lead screw and a second lead screw adapted for extending in a corresponding one of the first and second holes, the actuating means comprising a first and a second servomotor, each being operatively connected to a respective one of the first and second lead screws for moving said casing therealong, thereby moving said stator between said first position and said second position.

40. The system for decoupling a rotor from a stator of a permanent magnet motor according to claim 28, wherein the permanent magnet motor is adapted to supply a constant power over a given large rotational speed range adapted to an operating rotational speed range of a flywheel operatively connected to the permanent magnet motor.

41. A method for decoupling a rotor from a stator of a permanent magnet motor comprising:
sensing a rotational speed of the permanent magnet motor; and
displacing a selected one of the stator and the rotor between a first position wherein the stator extends around the rotor and a second position wherein the stator extends away from the rotor and is decoupled from the rotor according to the sensed rotational speed;
wherein a relative displacement of the stator away from the rotor enables a rotational speed of the permanent magnet motor greater than a base speed thereof.

42. The method for decoupling a rotor from a stator of a permanent magnet motor according to claim 41, wherein said displacing is performed in a continuous manner.

43. A flywheel energy storage system comprising:
a permanent magnet motor-generator having a stator and a rotor;
a rotating disc operatively connectable to the rotor; and
a system for decoupling a rotor from a stator of a permanent magnet motor according to claim 28, said system being operatively connected to the permanent magnet motor-generator for enabling a decoupling of the stator of the permanent magnet motor-generator from the rotor thereof.

44. The flywheel energy storage system according to claim 43, further comprising a coupling element for operatively connecting the rotating disc to the rotor.

45. The flywheel energy storage system according to claim 43, further comprising a rotating shaft operatively connected to the rotor and to the rotating disc.

46. The flywheel energy storage system according to claim 43, further comprising a vacuum containment vessel enclosing said flywheel energy storage system.

47. The flywheel energy storage system according to claim 45, wherein the rotating shaft is fixedly mounted with the rotor.
